(19) United States
(12) Patent Application Publication
(10) Pub. No.: US 2015/0042343 A1
(43) Pub. Date: Feb. 12, 2015

(54) OBJECT FINDER

(71) Applicants: Tobias Zibold, Stuttgart (DE); Andrej Albrecht, Stuttgart (DE)

(72) Inventors: Tobias Zibold, Stuttgart (DE); Andrej Albrecht, Stuttgart (DE)

(73) Assignee: Robert Bosch GmbH, Stuttgart (DE)

(21) Appl. No.: 14/355,990

(22) PCT Filed: Sep. 10, 2012
(86) PCT No.: PCT/EP2012/067600

§ 371 Date: Oct. 31, 2014

(30) Foreign Application Priority Data
Nov. 7, 2011 (DE) 10 2011 085 876.8

(51) Int. Cl. G01V 3/10; G01D 5/20

(52) U.S. Cl. CPC G01V 3/10; G01D 5/2006; G01V 3/104
USPC 324/326

(57) ABSTRACT

A device for detecting an object includes a coil for generating a magnetic field in the region of the coil, a first electrode for generating an electrical field in the region of the electrode, and an evaluating device for detecting the object on the basis of an influence of the magnetic field or the electrical field. The device also includes a separating device configured to suppress a current flow through the coil so as to use the coil as an electrode.

The invention relates to a device for detecting an object. In particular, the invention relates to a device for detecting the object on the basis of the magnetic or electric properties thereof.

### PRIOR ART

Various searching devices are known for detecting an object buried in a wall. In order to detect a metal object, for example a copper water pipe, a magnetic field can be generated and it can be checked whether the object influences the magnetic field. A non-metal object, such as a wooden beam, for example, can be detected capacitively on the basis of the dielectric properties thereof. For this purpose, an electric field can be generated and it can be checked whether the object influences the electric field. In both cases, the object is detected when the influence on the field exceeds a predefined measure.

If the object is a conductor through which current is flowing, then the object can also be detected on the basis of the electromagnetic field thereof. For example, a conventional AC voltage line can be detected on the basis of the surrounding electromagnetic alternating field at 50 or 60 Hz.

WO 2010/133328 A1 discloses a metal detector based on the inductive measuring method, which comprises two transmission coils and one receiver coil. The transmission coils are actuated such that the influences thereof on the receiver coil are identical. If one of the magnetic fields of the transmission coils is influenced by an object, the actuation of the transmission coils changes, such that the object can be detected on the basis of a control signal for the transmission coils.

In order to implement the magnetic measuring principle in alternation with or at the same time as the capacitive measuring principle, and therefore to detect the object on the basis of either the magnetic or the dielectric properties thereof, the sensors necessary for this are preferably arranged such that the detection regions thereof overlap. It is necessary in this case to ensure that the sensors do not each influence one another in order not to reduce the detection accuracy.

The problem addressed by the invention is to specify a device for detecting the object which enables a compact design for the individual sensors. The invention solves this problem by means of a device having the features of the independent claim. The dependent claims describe preferred embodiments.

### DISCLOSURE OF THE INVENTION

A device for detecting an object comprises a first coil for generating a magnetic field in the region of the coil, a first electrode for generating an electric field in the region of the first electrode and an evaluation device for detecting the object on the basis of an influence on the magnetic field or the electric field. In this case, a disconnecting device is provided for suppressing a flow of current through the coil in order to use the first coil as first electrode.

As a result, detection regions of the coil and the electrode can overlap in an improved manner. If the geometric location at which a sensor provides a maximum signal is considered to be the sensor center, the sensor centers of the coil and the electrode can therefore overlap in an improved manner. As a result, the object can be detected or localized with improved resolution. Classifiability of the object on the basis of the dielectric or magnetic properties thereof can also be improved. A surface area required for the sensors can be reduced. In this way, reduced manufacturing costs are possible.

The device can also be used with several coils in various embodiments. In one embodiment, the device also comprises a further first coil for generating a further magnetic field in the region of the further first coil, a further first electrode for generating a further electric field in the region of the further first electrode and a further disconnecting device for suppressing a flow of current through the further first coil, wherein the further first coil is used as further first electrode.

As a result, the magnetic and the dielectric properties of the object can be determined by means of a push-pull circuit which is connected to the two coils in order to perform a magnetic or capacitive measurement.

In another embodiment, the device also comprises a second coil for determining the magnetic field.

In this case, the device can also comprise a further first electrode for generating a further electric field in the region of the further first electrode, wherein the second coil is used as further first electrode.

In another embodiment, the device also comprises a second electrode for determining an electric field.

In yet another embodiment, the device comprises, in addition to the second coil and the second electrode, yet another disconnecting device for suppressing a flow of current through the second coil, wherein the second coil is used as second electrode.

In particular in the case of use of a push-pull circuit, a receiver coil can thus be used simultaneously or alternately as electrode for the capacitive detection of the object. Since the current through the receiver coil for determining the magnetic field is many times smaller than the current through the coil for generating the electric field, the current through the receiver coil can already be deemed suppressed when a very highly resistive measurement, for example by means of a transistor, is performed.

In a preferred embodiment, the first and second coils for generating the electric fields and used as electrodes lie in one plane and a further first coil for generating a magnetic field is arranged in a parallel plane. The parallel plane preferably lies opposite the object with reference to the first plane.

By means of the vertical arrangement of the sensor elements, installation space can be saved and sensor centers of the electrodes and the coils can be better aligned one above the other.

In this case, in a preferred embodiment, a shielding electrode is arranged between the planes. The electric field can thus be prevented from being short-circuited onto the second electrode by the further coil in the parallel plane.

In a preferred embodiment, the shielding electrode comprises a number of parallel conductor pieces, which can be electrically connected to one another. In this way, the shielding electrode can be constructed in a simple manner and with little use of materials. In addition, the construction using conductor pieces means that it is possible for an influence on the magnetic field by the shielding electrode to be reduced.

Preferably, the coil lies in one plane, wherein the coil can be embodied as a so-called printed coil on a printed circuit board. Manufacturing costs for the coil can be kept to a minimum as a result and an evaluation circuit can be constructed in a manner integrated with the coil.

In a particularly preferred embodiment, the coil for generating the magnetic field lies in one plane, wherein the second electrode is arranged in the same plane outside of the coil and the technical current direction at the coil runs from the interior to the exterior.

As a result, the coil can have, at the outer turns thereof, only low capacitive fundamental coupling to the second electrode owing to a voltage drop across the nonreactive resistance of the coil. A sensitivity of the capacitive detection of the object can be improved by the reduced fundamental coupling.

In particular when the coil is embodied as a printed coil, it is advantageous if the gap between adjacent turns is not larger than the width of one turn. As a result, if the coil is used as an electrode, it electrically more closely resembles a surface. As a result, the determination of the object in a capacitive way by means of the electrodes can be improved.

In a further preferred embodiment, the coil for generating the electric field and used as an electrode lies in one plane and is surrounded by a guard electrode. In the alternative with two coils for generating electric fields and used as electrodes in one plane, the guard electrode can also surround both coils. Also, in a further embodiment, each of the two coils used as electrodes can be surrounded or at least partially surrounded by an individual guard electrode.

As a result, stray capacitances which can influence the capacitive measurement can be kept to a minimum.

In a preferred embodiment, the evaluation device is connected to the second electrode in a highly resistive manner in order to determine the AC live object on the basis of the electric field thereof.

As a result, the second electrode can be used for a third measuring principle which goes beyond the described magnetic and capacitive determination. As a result, the object can be better detected or located.

A method according to the invention for detecting an object comprises the steps of providing a flow of current through a first coil in order to generate a magnetic field in the region of the first coil, scanning the magnetic field, detecting the object on the basis of an influence on the magnetic field, suppressing the flow of current through the first coil in order to generate an electric field in the region of the first coil, scanning the electric field, and detecting the object on the basis of an influence on the electric field.

In this way, the object can be simply and efficiently detected or located on the basis of the magnetic and/or dielectric properties thereof. The method is versatile and, in particular, can be performed by means of the described device. In this case, parts of the method can be implementable as computer program products, for example on a programmable microcomputer.

In a preferred embodiment of the method, the magnetic field is scanned while the flow of current through the first coil is provided, and the electric field is scanned while the flow of current through the first coil is suppressed. In this way, the first coil can be used consecutively to generate or scan a magnetic field and to generate or scan an electric field.

### BRIEF DESCRIPTION OF THE FIGURES

The invention will now be described in more detail with reference to the appended figures, in which:

FIG. 1 illustrates a schematic illustration of a device for detecting an object;

FIG. 2 illustrates an arrangement of coils of the device from FIG. 1 in different planes;

FIG. 3 illustrates two coils of the arrangement from FIG. 2 in one plane with an additional shield; and

FIGS. 4 to 6 illustrate various arrangements of electrodes and coils usable as electrodes.

### DETAILED DESCRIPTION OF THE EXEMPLARY EMBODIMENTS

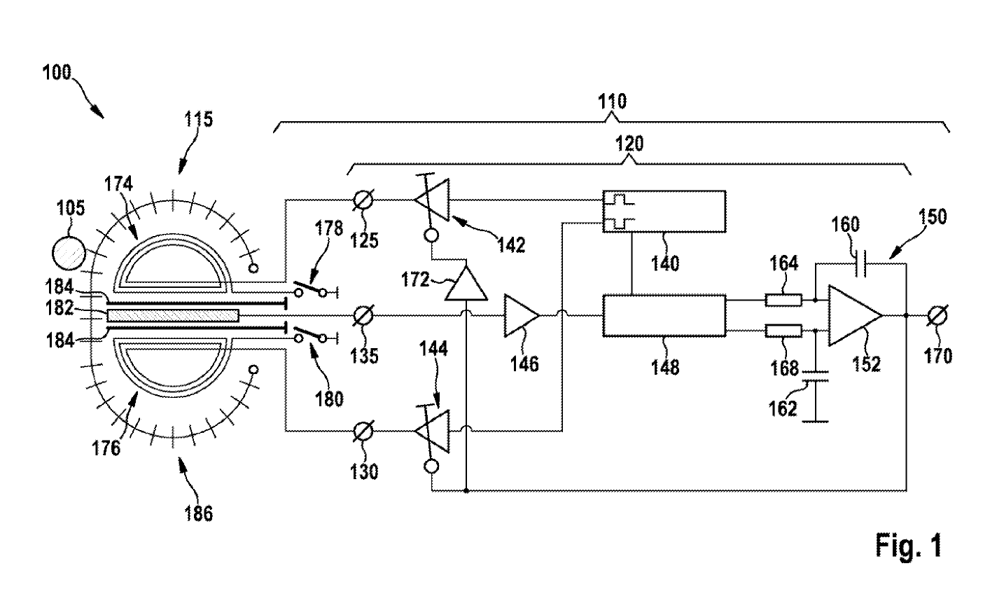

FIG. 1 shows a schematic illustration of a device 100 for detecting an object 105. The device 100 comprises an actuation circuit 110 and a sensor arrangement 115. The actuation circuit 110 comprises a push-pull circuit 120 which is connected to the sensor arrangement 115 by means of a first output 125, a second output 130 and an input 135.

The push-pull circuit 120 comprises a clock generator 140 which provides antiphase alternating signals of any signal shape, in particular sinusoidal, at two outputs. One output is connected to the first output 125 by means of a first controllable amplifier 142, and the other output is connected to the second output 130 by means of a second controllable amplifier 144. The two amplifiers 142, 144 are set up to provide in each case a signal at the outputs 125, 130, the current or voltage of which corresponds to the signal at the corresponding output of the clock generator 140.

The input 135 is connected to an input amplifier 146 to reduce the input impedance. The input amplifier 146 picks off at high impedance the signal present at the input 135, with the result that the measurement of the potential of the receiver electrode 182 influences the electrical relationships at the sensor arrangement 115 as little as possible. If the input impedance of the input amplifier 146 is sufficiently high, the input amplifier 146 can be regarded as a disconnecting device which suppresses a current through a receiver device, in particular a receiver coil for determining a magnetic field.

In one embodiment, an electromagnetic alternating field which is generated by the AC live object 105 can be detected by the receiver electrode 182 and the input amplifier 146. Preferably, the first coils 174, 176 are not energized in this case and the output of the input amplifier 146 is connected to a frequency filter in the range of approximately 50-60 Hz in order to detect a power cable of a conventional grid installation as the object.

By means of a synchronous demodulator 148, a signal provided by the input amplifier 146 is demodulated. The demodulation occurs in sync with the clock signal generated by means of the clock generator 140. The signal of the input amplifier 146 is passed to one of the outputs of the synchronous demodulator 148 when one of the outputs of the clock generator 140 is active and to the other output of the synchronous demodulator 148 when the other output of the clock generator 140 is active.

The signals at the two outputs of the synchronous demodulator 148 are positively or negatively integrated by means of an integrator 150. In the illustrated exemplary embodiment, the integrator 150 is based on a comparator 152 having two capacitors 160, 162 and two resistors 164 and 168. The output of the integrator 150 is provided at an interface 170 for further processing.

In addition, the output of the integrator 150 is used to control the two controllable amplifiers 142 and 144, wherein an inverter 172 ensures that the gains of the amplifiers 142, 144 react to the signal at the output of the integrator 150 in opposite directions. In another embodiment, it is also possible for only one of the amplifiers 142, 144 to be controllable.

Electrodes for generating electric fields or coils for generating magnetic fields can be connected to the outputs 125, 130 in a known manner, the effect of said fields being scanned by a suitable scanning element and routed to the input 135. The push-pull circuit 120 then controls a relative equilibrium of the electric or magnetic fields with respect to the scanning element.

If the equilibrium is disturbed, in particular by the object 105 influencing one of the electric or magnetic fields more strongly than the other, then the relative equilibrium is restored by means of the push-pull circuit 120, wherein the signal present at the interface 170 reflects the changed balance. In other words, the object 105 can be determined on the basis of the magnetic or dielectric properties thereof by checking whether the signal present at the interface 170 is sufficiently different from a predefined value.

The illustrated sensor arrangement 115 is set up to support both the inductive and the capacitive measurement. A first coil 174 for generating a magnetic field is connected to the first output 125, wherein the first transmission coil 174 is preferably embodied as a flat coil (printed coil), the turns of which lie in one plane. In a corresponding manner, the second output 130 is connected to the inner end of a further first coil 176, the outer end of which can be connected to ground by means of a second switch 180. The first coils 174, 176 serve as transmission coils for generating overlapping magnetic fields. The switches 178, 180 serve as disconnecting devices for suppressing a current through the coils 176 or 176 and can be realized, for example, as transistors. A filter element (for example an RC element), which permits the flow of current for certain frequencies and suppresses it for others, can also be used as a disconnecting device.

Preferably, the first coils 174, 176 have the illustrated D-shaped cross sections, wherein the straight sections of both first coils 174, 176 run parallel to one another. In a preferred embodiment, the remaining sections of the first coils 174, 176 are at the same distance from a common center point, with the result that the first coils 174, 176 complement one another to form a circular area, from which D-shaped center regions of the first coils 174, 176 and a strip running through the center point are not covered by the first coils 174, 176.

A receiver coil or another device for determining a magnetic field in the region of the overlapping magnetic fields of the first coils 174 and 176 is not illustrated in FIG. 1. When a receiver coil is used, both ends of said receiver coil are preferably connected to the input 135 or to the input amplifier 146, wherein the input amplifier 146 performs a differential measurement. During inductive determination of the object 105, the switches 178, 180 are closed in order to enable a flow of current through the first coils 174, 176, which is necessary for generating the magnetic fields.

The technical current direction of the amplifiers 125, 130 through the first coils 174, 176 preferably runs in the winding direction from the interior to the exterior, with the result that, owing to the nonreactive resistance over the turns of the individual first coils 174 and 176, sections of the turns of the first coils 174 and 176 which are close to the receiver electrode 182 have only a relatively low voltage with reference to ground. This results in relatively low capacitive fundamental coupling between the first coil 174 or 176 used as capacitive electrode and the receiver electrode 182. By means of the low capacitive fundamental coupling, an inductive and a capacitive measurement can take place exactly at the same time or in quick succession at the sensor arrangement 115.

In order to perform capacitive determination of the object 105, the first coils 174, 176 are used as electrodes which generate overlapping electric fields. For this purpose, the switches 178, 180 are opened, with the result that a flow of current through the first coils 174, 176 is suppressed, although the first coils 174, 176 are supplied with voltages by the amplifiers 142, 144. The individual turns of the first coils 174 and 176 are preferably close to each other, with the result that the surfaces of the first coils 174, 176 can be considered as flat electrodes which each build up an electric field which can be scanned by means of a receiver electrode 182 situated between the first coils 174, 176.

The receiver electrode 182 for determining the electric field in the overlap region is connected to the input 135 and preferably extends along the direction of the sections of the turns of the first coils 174 and 176, which sections run parallel to one another. In another embodiment, in each case a shielding electrode 184 is arranged between the receiver electrode 182 and each of the first coils 174, 176. The shielding electrodes 184 are connected to ground and serve to minimize a fundamental capacitance between the first coil 174 or 176 and the receiver electrode 182. Preferably, the shielding electrodes 184 are geometrically shaped such that they lie in a plane with the first coils 174, 176 and the receiver electrode 182, with the result that the receiver electrode 182 and the first coil 174 or 176 lie opposite one another with reference to the respective shielding electrode 184.

In another preferred embodiment, a guard electrode 186 is provided which surrounds the first coil 174 and, if present, the further first coil 176, the receiver electrode 182 and the shielding electrodes 184 in the plane in which they lie. The guard electrode 186 serves to minimize stray capacitances in the interior thereof. Preferably, the guard electrode 186 is tracked to the potential of the first coil 174. Isolated guard electrodes 186 can also be provided for the first coils 174, 176, wherein each guard electrode is tracked to the potential of the first coil 174, 176 assigned thereto. It is also possible for the first coils 174, 176 to be only partially surrounded by guard electrodes.

In one embodiment, the guard electrode 186 is designed to have a meandering shape by comprising a number of conductor pieces which are electrically connected to one another and radially point to a center point of the guard electrode 186, which preferably lies in the region of the receiver electrode 182.

In another embodiment, the sensor arrangement 115 can be used in accordance with the manner described above to detect the object 105 in a magnetic or capacitive manner, even without use of the push-pull circuit 120. In this case, a magnetic field is always built up or determined while the switches 178, 180 are closed, with the result that a flow of current through the first coils 176, 178 is enabled, and an electric field is built up or determined while the switches 178, 180 are open, with the result that the flow of current is suppressed. An influence by the object 105 on the magnetic or electric fields can be detected by measuring the respective field in the region of the first coils 176, 178 or by monitoring the electrical parameters, such as the current, through the coils 176, 178. In yet another embodiment, only the first coil 176 can be used for this, while the further first coil 178 is omitted.

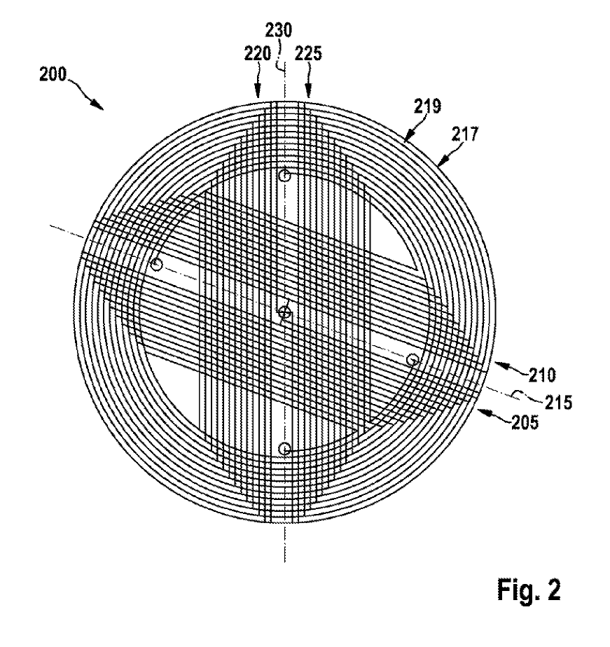

FIG. 2 shows an arrangement 200 of coils of the device 100 from FIG. 1 in different planes. The illustration 200 in this case comprises the coils from both planes.

A first coil 205 and a further first coil 210 are arranged in a lower plane which faces toward the object 105. Both coils 205 and 210 are D-shaped, wherein sections of the coils 205 and 210 which are parallel to one another run parallel to a first axis 215. Turns 217 of the coils 205, 210 lie in the plane, and gaps 219 which are enclosed in each case between adjacent turns 217 are as narrow as possible, preferably narrower than the turns 217. The coil 205 can in particular be operated as first coil 174 in the device 100 from FIG. 1.

In a second, upper plane, which is parallel to the first plane, a third coil 220 and a fourth coil 225 are arranged, said coils being shaped in accordance with the coils 205, 210 and oriented with reference to a second axis 230. In a preferred embodiment, the coils 205, 210, 220 and 225 are realized on different planes (layers) of a printed circuit. The coil 220 can in particular be operated as further first coil 176 in the device 100 from FIG. 1.

The coils 210 and 225 can be used to detect the magnetic fields which were generated by the coils 205 and 220. For this purpose, the coils 210 and 225 can be electrically connected to one another.

In other embodiments, the coils 210, 225, which are provided for determining the magnetic field determined by the other two coils 205 and 220, can also be realized differently. By way of example, the coils 220, 225 can be shifted and/or rotated in the parallel plane with respect to the coils 205 and 210.

It is not absolutely necessary to use the coils 210, 225 to determine the magnetic fields generated by the coils 205, 220; in another embodiment, another device, for example a Hall sensor or an AMR sensor, can also be used for this purpose.

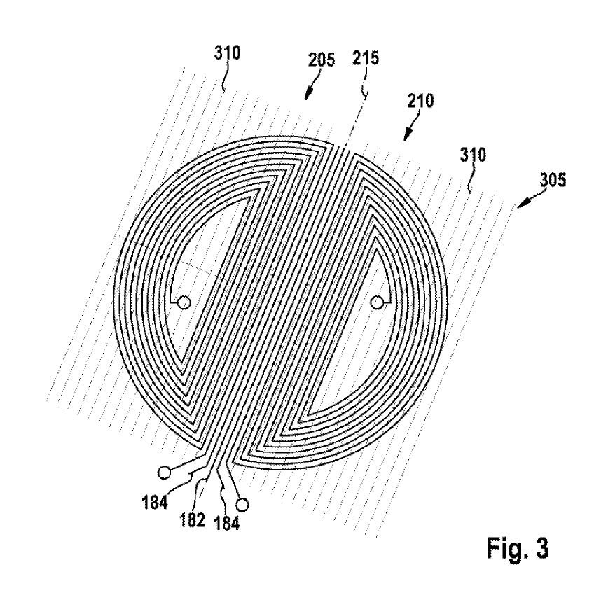

FIG. 3 shows the coils 205 and 210, together with the structures—lying between said coils—of the receiver electrode 182 and the shielding electrodes 184, in conjunction with a shield 305. The shield 305 preferably runs in a plane which lies between the planes of the coils 205, 210 and 220, 225.

The shield 305 is embodied in a meandering fashion and comprises a multiplicity of straight conductor pieces 310, which preferably run parallel to the first axis 215. In this case, a region between the coils 205 and 210 is not covered by conductor pieces 310. The conductor pieces 310, which are assigned in each case to one of the coils 205 or 210, are electrically connected to one another. The shield 305 is connected to ground in order to shield against electric fields in the vertical direction, that is to say perpendicular to the planes in which the coils 205 and 210 lie. In a preferred embodiment, the shield 305 is applied in a separate plane of a multilayer printed circuit board and plated-through as appropriate in the vertical direction.

Preferably, the coils 220 and 225 from FIG. 2 are again shielded by means of a separate shield 305, with conductor pieces 310 which run parallel to the second axis 230. Both shields 305 preferably run between the planes in which the coil pairs 205, 210 and 220, 225 are arranged. The shields 305 can be electrically connected to one another, for example by means of a plated-through hole.

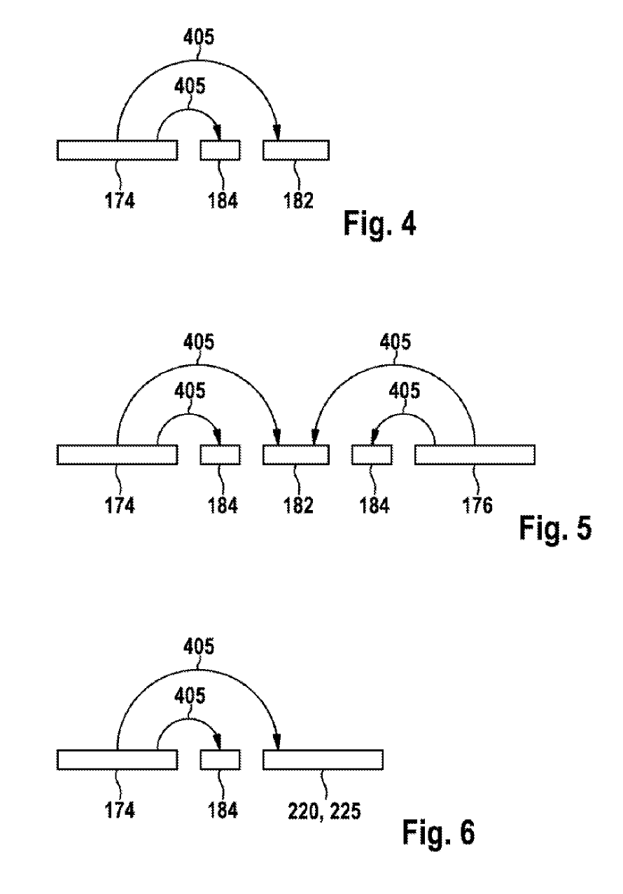

FIGS. 4 to 6 show arrangements of electrodes and coils, which are usable as electrodes, of the sensor arrangement 115 from FIG. 1 with reference to the coils from FIGS. 2 and 3.

In the arrangement illustrated in FIG. 4, the first coil 174, the shielding electrode 184 and the receiver electrode 182 are arranged in one plane. The first coil 174 is usable as an electrode in order to build up an electric field with respect to the receiver electrode 182. Some of the field lines 405 which originate from the first coil 174 run in a flat manner with respect to the shielding electrode 184 while others run in a relatively high arc with respect to the receiver electrode 182. The field between the first coil 174 and the receiver electrode 182 can only be influenced by the object 105 if said object cuts the field line 405 running between these two elements. Field lines 405 which run relatively close to the plane in which the elements 174, 184 and 182 are arranged cannot run through the object 105 since the object 105 is too far away in the vertical direction. Said field lines 405 end at the shielding electrode 184, with the result that the fundamental capacitance between the first coil 174 and the receiver electrode 182 is reduced. A dynamic measurement range for determining the object 105 can be increased as a result.

FIG. 5 shows an arrangement similar to that shown in FIG. 4, which is designed symmetrically in accordance with the illustration from FIG. 1, however. Shielding electrodes 184 are located on both sides of the receiver electrode 182, the first coils 174 and 176, which are usable as electrodes, being arranged on the other sides of said shielding electrodes.

FIG. 6 shows yet another arrangement corresponding to that shown in FIG. 4, wherein the receiver electrode 182 is likewise formed by a coil, for example by one or both of the coils 220, 225 from FIG. 2.

A coil, in particular a flat coil, can be used as an electrode for capacitive determination of the object 105 in the manner shown. This use may be particularly advantageously successful in conjunction with the push-pull circuit 120 from FIG. 1. However, the sensor arrangement 115 from FIGS. 1 to 6 and/or combinations thereof can also be combined with another circuit in order to detect the object 105 either in a capacitive or in an inductive manner.

1. A device for detecting an object, comprising:
a first coil configured to generate a magnetic field in the region of the first coil;
a first electrode configured to generate an electric field in the region of the first electrode;
an evaluation device configured to detect the object on the basis of an influence on the magnetic field or the electric field; and
a disconnecting device configured to suppress a flow of current through the first coil so as to use the first coil as the first electrode.

2. The device as claimed in claim 1, further comprising:
a further first coil configured to generate a further magnetic field in the region of the further first coil;
a further first electrode configured to generate a further electric field in the region of the further first electrode; and
a further disconnecting device configured to suppress a flow of current through the further first coil so as to use the further first coil as the further first electrode.

3. The device as claimed in claim 2, further comprising a second coil configured to determine the magnetic field in the region of at least one of the first coils.

4. The device as claimed in claim 3, wherein the second coil is used as the further first electrode.

5. The device as claimed in claim 3, further comprising a second electrode configured to determine the electric field in the region of at least one of the first electrodes.

6. The device as claimed in claim 5, further comprising a disconnecting device configured to suppress a flow of current through the second coil so as to use the second coil as the second electrode.

7. The device as claimed in claim 3, wherein the first coil and the second coil lie in one plane and the further first coil is arranged in a parallel plane.

8. The device as claimed in claim 7, wherein a shielding electrode is arranged between the planes.

9. The device as claimed in claim 8, wherein the shielding electrode comprises a number of parallel conductor pieces.

10. The device as claimed in claim 3, wherein the coil configured to generate the magnetic field lies in one plane, the second electrode is arranged in the same plane outside of the coil and the technical current direction at the coil runs from the interior to the exterior.

11. The device as claimed in claim 1, wherein the coil lies in one plane and the gap between adjacent turns is not larger than the width of one turn.

12. The device as claimed in claim 1, wherein the electrode configured to generate the electric field lies in one plane and is surrounded by a guard electrode.

13. The device as claimed in claim 5, wherein the evaluation device is connected to the second electrode in a highly resistive manner in order to determine the AC live object on the basis of the electric field thereof.

14. A method for detecting an object, comprising:
providing a flow of current through a first coil in order to generate a magnetic field in the region of the first coil;
scanning the magnetic field;
detecting the object on the basis of an influence on the magnetic field;
suppressing the flow of current through the first coil in order to generate an electric field in the region of the first coil;
scanning the electric field; and
detecting the object on the basis of an influence on the electric field.

15. The method as claimed in claim 14, wherein the magnetic field is scanned while the flow of current through the first coil is provided, and the electric field is scanned while the flow of current through the first coil is suppressed.
